(19) United States
(12) Patent Application Publication
(10) Pub. No.: US 2023/0060533 A1
(43) Pub. Date: Mar. 2, 2023

(54) CONTACT ASSEMBLY FOR AN ELECTRICAL PLUG-IN CONNECTOR AND METHOD FOR PRODUCING AN ELECTRICAL PLUG-IN CONNECTOR

(71) Applicant: Rosenberger Hochfrequenztechnik GmbH & Co. KG, Fridolfing (DE)

(72) Inventors: Willem BLAKBORN, Inzell (DE); Martin AUER, Tyrlaching (DE); Andreas BEICHT, Burghausen (DE)

(21) Appl. No.: 17/893,272

(22) Filed: Aug. 23, 2022

(30) Foreign Application Priority Data
Aug. 24, 2021 (EP) 21 192 843.7

(51) Int. Cl. H01R 13/533; H01R 13/11; H01R 13/03; H01R 13/502

(52) U.S. Cl. CPC H01R 13/533; H01R 13/111; H01R 13/03; H01R 13/502; H01R 2201/26

(57) ABSTRACT

A contact assembly (9) for an electrical plug-in connector (2), having a sleeve-shaped contact element (4, 5) made from a metallic first material. The contact element (4, 5) has a first lateral surface (10) for making electrical and mechanical contact with a mating contact element (7, 8) of a mating electrical plug-in connector (3) and a second lateral surface (11) different from the first lateral surface (10). It is provided that the contact assembly (9) has a delimiting element (12) preferably made of a second material different from the first material. The delimiting element (12) is fastened to the second lateral surface (11) of the contact element (4, 5) at least in certain portions and has a higher high-temperature strength than the contact element (4, 5).

### CROSS REFERENCE TO RELATED APPLICATION

This US Utility patent application claims the benefit of and priority to European Patent Application No. 21 192 843.7, filed on Aug. 24, 2021, the entire disclosure of which is incorporated herein by reference.

### TECHNICAL FIELD

The invention relates to a contact assembly for an electrical plug-in connector, which has a sleeve-shaped contact element made of a metallic first material, according to the preamble of claim 1.

The invention also relates to an electrical plug-in connector, in particular a high-voltage plug-in connector, and to an electrical plug-in connection composed of said plug-in connector and a corresponding mating electrical plug-in connector.

The invention moreover relates to a method for producing an electrical plug-in connector.

### BACKGROUND OF THE INVENTION

Various electrical plug-in connectors are known from electrical engineering. As is known, electrical plug-in connectors serve to transmit electrical supply signals and/or data signals to corresponding mating electrical plug-in connectors. A plug-in connector or mating plug-in connector may be a plug, a panel plug, a socket, a coupling or an adapter, for example. The designation “plug-in connector” and “mating plug-in connector”, respectively, used within the scope of the invention are representative of all variants.

Special requirements are placed on electrical plug-in connectors, in particular in the high-voltage range. In vehicle engineering, high-voltage plug-in connectors are used primarily in the case of electric and hybrid vehicles to supply charge current to a vehicle battery in order to remove the stored energy from the battery and feed it to the electric drive or to interconnect multiple batteries or battery modules. In this respect, the electrical plug-in connection must permanently and reliably prevent penetration of moisture and dirt and ensure satisfactory transmission of high currents. Moreover, the plug-in connection, in particular a high-voltage plug-in connection or a plug-in connection for transmitting safety-relevant control signals, should be mechanically robust and be reliably secured against unintended opening.

It is frequently the case that electrical plug-in connectors, in particular plug-in connectors for vehicle engineering, must be cost-effectively producible within the scope of mass production. For this reason, contact elements of plug-in connectors, in particular external conductor contact elements, are preferably produced by a die casting method.

However, it has been shown that the contact elements produced in this way can lose their shape or be plastically deformed at high temperatures, as can arise for example when transmitting current in high-voltage engineering.

This is a problem in particular when the plug-in connection involves a force fit between the plug-in connector and the mating plug-in connector, as is the case when there is an interference fit between the external conductor contact elements involved. In particular in this case, it is possible that the electrical contact and/or the mechanical contact in the plug-in connection worsen(s) at high temperatures.

### SUMMARY OF THE INVENTION

In view of the known prior art, the object of the present invention is to provide a contact assembly that can be produced economically within the scope of mass production and that nevertheless has high thermal stability, and that is thus preferably suitable for use in a high-voltage plug-in connector.

The present invention is also based on the object of providing an electrical plug-in connector that can be produced economically within the scope of mass production and that nevertheless has high thermal stability, and that is thus preferably suitable for use as a high-voltage plug-in connector.

Lastly, another object of the invention is to provide an electrical plug-in connection that can be produced economically within the scope of mass production and that nevertheless has high thermal stability, and that is thus preferably suitable for use as a high-voltage plug-in connection.

It is moreover an object of the invention to provide an economic method for producing an electrical plug-in connector with high thermal stability.

The object is achieved for the contact assembly having the features set out in claim 1. In terms of the electrical plug-in connector, the object is solved by the features of claim 11, and in relation to the electrical plug-in connection the object is solved by claim 12. For the method, the object is solved by claim 14.

The dependent claims and the features described below relate to advantageous embodiments and variants of the invention.

What is provided is a contact assembly for an electrical plug-in connector, which has a contact element that is sleeve-shaped at least in certain portions and is made from a metallic first material. The contact element has a first lateral surface for making electrical and mechanical contact with a mating contact element of a mating electrical plug-in connector and a second lateral surface different from the first lateral surface.

The electrical plug-in connector is preferably a high-voltage plug-in connector, which is suitable for the transmission of high electric currents. The contact assembly, in particular the contact element of the contact assembly, is therefore preferably designed to be suitable for the transfer of electrical energy in high-voltage engineering, that is to say for the transmission of high electric currents (for example 100 A to 700 A) given AC voltages of 30 V to 1 kV or more or DC voltages of 60 V to 2 kV or more, in particular in vehicle engineering.

In principle, the contact assembly can also be advantageous for plug-in connectors for energy transfer and/or data transmission with only low electric currents.

A sleeve-shaped contact element can be understood to mean in particular a ring-shaped or tubular contact element (preferably an elongate contact element) with a round cross section, but optionally also elliptical, rectangular or other cross section.

The sleeve-shaped contact element does not have to be completely closed and may therefore also have the form of only part of a ring, for example, and/or may have cutouts, in particular axial slots.

The sleeve-shaped contact element does not need to be sleeve-shaped or have a hollow form over the entire longitudinal extent. The sleeve-shaped contact element may also have a sleeve-shaped contact region, for example also only in a front end portion intended to make contact with the mating contact element, in order for example to be connectable to pin-shaped mating contact elements of the mating plug-in connector.

As will also be described below, the sleeve-shaped contact element of the contact assembly can preferably be in the form of an external conductor contact element of the plug-in connector. However, the sleeve-shaped contact element may also be in the form of an internal conductor contact element of the plug-in connector.

The second lateral surface is preferably a lateral surface facing away from the first lateral surface.

The first lateral surface and/or the second lateral surface may each be a completely continuous surface, but may optionally also each be composed of multiple individual surfaces, in particular when the contact element is slotted or has cutouts which extend through the respective lateral surface.

In principle, the first material can be any desired metallic material, but preferably is a zinc material or an aluminum material, or at least one alloy comprising zinc and/or aluminum is provided.

According to the invention, the contact assembly has a delimiting element. The delimiting element is preferably made from a second material different from the first material. It is provided that the delimiting element has a higher strength at elevated temperatures (known as “elevated-temperature strength” or “high-temperature strength”) than the contact element (in particular, it may be provided that the second material has a higher high-temperature strength than the first material). The delimiting element is fastened to the second lateral surface of the contact element at least in certain portions (but preferably over its entire surface area).

As is known, the high-temperature strength is a characteristic value denoting the strength or structural robustness, especially the yield strength, of a material at elevated temperatures. A material or an object with high strength at elevated temperatures (“high-temperature strength”) therefore requires higher external forces to be deformed, or has less of a tendency to deform, at a defined temperature than a material or an object with lower high-temperature strength.

In a particularly preferred refinement of the invention, provision may in particular be made for the second material to have a lower coefficient of thermal expansion than the first material.

The coefficient of thermal expansion (also known as “thermal expansion coefficient” or simply just “expansion coefficient”) is a characteristic value describing the behavior of a material with respect to changes in its dimensions in the event of temperature changes caused by thermal expansion. The coefficient of thermal expansion can also be referred to as coefficient of linear thermal expansion (also known as “linear thermal expansion coefficient”), coefficient of areal thermal expansion (also known as “areal thermal expansion coefficient”) or coefficient of volumetric thermal expansion (also known as “volumetric thermal expansion coefficient”).

The coefficient of linear thermal expansion of the second material is preferably less than 20/10⁶K, particularly preferably less than 15/10⁶K, very particularly preferably less than 13/10⁶K, and even more preferably less than 12/10⁶K.

The delimiting element may also be referred to as support element, stabilizing element or reinforcing element. The delimiting element advantageously makes it possible to mechanically delimit thermal deformation of the contact element, in particular movement of the contact element caused by a thermal process, for example thermal expansion or thermal creep.

The delimiting element can therefore advantageously be used to stabilize the contact element. The separate support structure provided by the delimiting element makes it possible to make the contact element more suitable, in particular for use at high operating temperatures caused by a high transfer of current, for example, as a result of which the contact assembly can have better dimensional stability at high temperatures than the contact element alone. The delimiting element may thus prevent dimensional change of the contact element—in particular dimensional change in a radial direction with respect to the center axis or longitudinal axis of the contact assembly or of the plug-in connector—and therefore removal of the contact element from the corresponding mating contact element.

An electrical plug-in connector equipped with the contact assembly proposed is suitable especially advantageously for the transmission of high currents or safety-relevant signals, since even given adverse environmental conditions, such as high temperatures or high pressure, it can be reliably ensured that the electrical and/or mechanical connection to the mating plug-in connector does not deteriorate.

As a result of the fact that the delimiting element has a higher high-temperature strength than the contact element, the contact assembly overall has improved strength at elevated temperatures over the contact element.

At the same time, the proposed contact assembly can be produced particularly easily and cost-effectively, since as before, for example, the contact element can be produced by means of die casting technology and then reinforced by means of a simple delimiting element with only a small material requirement.

In one refinement of the invention, it may be provided that the first lateral surface is an inner surface of the contact element, and the second lateral surface is an outer surface, facing away from the inner surface, of the contact element.

The contact element can therefore be contactable on the inside by the corresponding mating counter element of the mating plug-in connector, by plugging the mating contact element into the contact element. An outer lateral surface of the mating contact element can therefore establish mechanical and electrical contact with the first lateral surface of the contact element, preferably over its full surface area, but optionally also only in certain portions.

In this case, the sleeve-shaped contact element is preferably designed also for yet further components of the plug-in connector to be guided therein, for example a dielectric or an insulator and optionally further contact assemblies or contact elements, such as one or more internal conductor contact elements.

The delimiting element may be applied to the outside of the contact element, preferably over its full surface area, but optionally also only in certain portions, and therefore advantageously prevent temperature-induced expansion of the contact element, as a result of which an internal loss of contact with the mating contact element can be prevented. The delimiting element may be designed in the manner of a cage sleeve, in order to prevent the contact element being radially outwardly removed from the mating contact element in the event of a rise in temperature.

In an advantageous refinement of the invention, however, it may be provided in particular that the first lateral surface is an outer surface of the contact element, and the second lateral surface is an inner surface, facing away from the outer surface, of the contact element.

The contact element can therefore be contactable on the outside by the corresponding mating counter element of the mating plug-in connector, by plugging the mating contact element onto the contact element or plugging the contact element into the mating contact element. The mating contact element can therefore preferably have a sleeve-shaped form. An inner lateral surface of the mating contact element can therefore establish mechanical and electrical contact with the first lateral surface of the contact element, preferably over its full surface area, but optionally also only in certain portions.

In this case, the delimiting element may be introduced into the contact element, preferably over its full surface area, but optionally also only in certain portions, and therefore advantageously prevent temperature-induced expansion of the contact element, as a result of which an external loss of contact with the mating contact element can be prevented. The delimiting element may be designed in the manner of a cage sleeve, in order to prevent the contact element being radially inwardly removed from the mating contact element in the event of a rise in temperature.

Advantageously, lastly provision may be made for the contact element to be arranged between the delimiting element and the mating contact element, when the plug-in connector is connected to the mating plug-in connector.

It is also optionally possible for multiple delimiting elements per contact assembly to be provided.

In principle, the delimiting element may have any desired form. The delimiting element can support the contact element, for example taking a surrounding structure (such as a plug-in connector housing) as a starting point, essentially at certain points or in certain portions in a web-like, rib-like or pin-like manner. For example, the surface of the delimiting element that faces the second lateral surface of the contact element may be structured.

According to a preferred refinement of the invention, however, it may in particular be the case that the delimiting element has a sleeve-shaped form or is at least partially in the form of part of a ring.

In particular, a sleeve-shaped delimiting element makes it possible to protect the contact element particularly effectively against undesired thermal expansion.

A sleeve-shaped delimiting element can be understood to mean in particular a ring-shaped or tubular delimiting element with a round cross section, but optionally also elliptical, rectangular or other cross section. The sleeve-shaped delimiting element does not have to be completely closed and may therefore also have the form of only part of a ring, for example, and/or may have cutouts, in particular axial slots.

As has already been mentioned, it is also possible if appropriate for multiple delimiting elements to be provided, for example two delimiting elements, three delimiting elements, four delimiting elements or yet more delimiting elements. Insofar as multiple delimiting elements are provided, they may be arranged axially offset, in particular axially spaced apart, along a common contact element, for example. An arrangement of an additional delimiting element, which is also fastened to the first lateral surface of the contact element at least in certain portions, may also be provided. Generally, however, just one delimiting element is sufficient.

In principle, the second material of the delimiting element may be any desired material, for example a metal, a plastic, a ceramic or a combination of various materials.

According to one refinement of the invention, it may be provided in particular that the second material of the delimiting element is a metallic material.

The second material can preferably be an iron material, steel material or brass material. In principle, however, it is also possible to provide other materials, in particular other ones of the metals mentioned, for the purpose of forming the second material.

In one refinement of the invention, it may be provided that the delimiting element extends annularly circumferentially along the second lateral surface of the contact element.

The delimiting element preferably rests on the second lateral surface at least in certain portions, in particular completely or over all of its surface area.

In one refinement of the invention, it may be provided that the delimiting element is fastened to the second lateral surface of the contact element by a force fit.

In particular, the delimiting element can be fastened to the contact element by means of an interference fit, preferably directly, but also only indirectly if appropriate (e.g. by arranging a further element between the contact element and the delimiting element).

In an advantageous refinement of the invention, it may also be provided for the delimiting element to be fastened to the second lateral surface via a threaded connection formed between the delimiting element and the second lateral surface of the contact element.

In principle, any desired connection techniques can be suitable for connecting the delimiting element and the contact element to one another directly or indirectly. A snap connection between the delimiting element and the contact element may also be provided, for example, in order to fasten the delimiting element to the second lateral surface.

In one refinement of the invention, it may be provided for the delimiting element to be fastened to an axial end portion of the contact element that is provided for the connection to the mating contact element.

The support of the contact element is advantageous or has a particularly effective action in particular in the region in which the contact element is to be connected to the mating contact element. In principle, however, for example because of the structure, it is also possible to provide an axial offset of the delimiting element with respect to the contact position between the contact element and the mating contact element.

The delimiting element particularly preferably extends from the axial end portion, particularly preferably from the axial end of the contact element, toward the end of the contact element that faces away from the mating contact element.

In an advantageous refinement of the invention, it may be provided that the contact element has a first axial stop (in particular a step or a rib), axially directly adjoining the second lateral surface, for the delimiting element.

A stop for the delimiting element may in particular be advantageous in order to prevent axial slipping of the delimiting element under adverse environmental conditions and to simplify the mounting of the delimiting element on the contact element.

The invention also relates to an electrical plug-in connector, in particular a high-voltage plug-in connector, having at least one contact assembly in accordance with the preceding and subsequent embodiments.

The proposed electrical plug-in connection can safely maintain an electrical and mechanical connection even given adverse environmental conditions, in particular given high temperatures that arise in the course of transmitting a high current. In particular, it is possible to ensure the required holding force, low-resistance electrical transmission, and high and resistant electromagnetic compatibility even at temperatures of above 140° C., for example.

The proposed plug-in connector is therefore especially advantageously suitable as a high-voltage plug-in connector, in particular for use within the scope of electromobility. The electrical plug-in connector advantageously makes it possible for example to provide a cell module connector interface for connecting battery cell modules given a particularly high temperature resistance of the contact connection.

In the present case, the term “high-voltage” is intended to relate in particular to systems for vehicle engineering. Within the meaning of the present invention, high-voltage transmission can relate in particular to AC voltages of over 30 V to 1 kV or more or to DC voltages of over 60 V to 2.0 kV or more. The contact element and/or the mating contact element is preferably configured for the transmission of high electrical currents (e.g. up to 100 A, up to 200 A, up to 300 A, up to 400 A, up to 500 A, up to 600 A, up to 700 A, up to 1500 A, up to 2000 A, or more) at preferably high electrical voltages (e.g. up to 500 V, up to 600 V, up to 700 V, up to 800 V, up to 900 V, up to 1000 V, up to 1100 V, up to 1500 V, up to 2000 V, or more).

In principle, however, the invention can be suitable for the transmission of any desired supply and/or communications signals, for example also for use in high-frequency engineering.

In an advantageous refinement of the invention, it may be provided that at least one of the contact elements made suitable by a delimiting element is in the form of an external conductor contact element of the plug-in connector. However, an external conductor contact element is not absolutely necessary—the plug-in connector may also have just one or more internal conductor contact elements, for example.

It may therefore also be provided for at least one of the contact elements made suitable by a delimiting element to be in the form of an internal conductor contact element, it also being possible depending on the plug-in connector for multiple internal conductor contact elements of this type to be provided, for example two, three, four, five, or even more internal conductor contact elements.

In particular, it may also be provided for all of the contact elements of the plug-in connector to be made suitable according to the invention by a delimiting element.

The invention also relates to an electrical plug-in connection, having an electrical plug-in connector in accordance with the preceding and subsequent embodiments, and to the corresponding mating electrical plug-in connector.

According to the invention, it is possible in particular to maintain a force-fitting connection between the plug-in connector and the mating plug-in connector even at high temperatures (e.g. in the case of temperatures >85° C.). The proposed electrical plug-in connector may provide a high residual holding force and low transmission resistance even at high temperatures and/or reliably withstand high mechanical loading even at high temperatures.

The plug-in connection according to the invention and the contact assembly may be used particularly advantageously within a vehicle, in particular a motor vehicle. In this case, the term “vehicle” describes any means of locomotion, in particular land vehicles, watercraft or aircraft, also including spacecraft. Possible fields of use are in particular high-voltage plug-in connections, primarily in the case of electric and/or hybrid vehicles. However, the plug-in connection according to the invention and the contact assembly are suitable for any desired applications within the entire field of electrical engineering, and should not be understood as being restricted to use in vehicle engineering and also not to use in high-voltage engineering.

It should be mentioned at this juncture that, if appropriate, the mating electrical plug-in connector may also have a contact assembly or multiple contact assemblies in accordance with the preceding and subsequent embodiments. The invention therefore also relates to a mating electrical plug-in connector (in particular a high-voltage electrical plug-in connector) for connection to a corresponding plug-in connector, the mating plug-in connector having at least one contact assembly in accordance with the preceding and subsequent embodiments.

A corresponding reinforcement of at least one contact element of the mating plug-in connector in addition to the reinforcement of at least one contact element of the plug-in connector can further improve the strength of the plug-in connection at elevated temperatures, if appropriate. However, a reinforcement of the contact element of the plug-in connector, for the one part, and of the contact elements of the mating plug-in connector, for the other part, is not absolutely necessary. Generally, it may already be sufficient to provide just the plug-in connector or the mating plug-in connector with one or more of the contact assemblies described.

In an advantageous refinement of the invention, it may be provided that the contact element of the electrical plug-in connector is connected by a force fit to the mating contact element of the mating electrical plug-in connector in the connected state of the electric plug-in connector.

The mechanical connection between the plug-in connector and the mating plug-in connector may be provided by means of an interference fit between at least one of the contact elements and one of the mating contact elements.

Even if an interference fit for connecting the plug-in connection may be particularly preferred, it is also possible for yet further connecting techniques to be provided (as an alternative or in addition), for example a screwed connection between the plug-in connector and the mating plug-in connector and/or a latching connection. The present invention is advantageously suitable in principle in combination with all conventional connection techniques between a plug-in connector and a mating plug-in connector.

The invention also relates to a method for producing an electrical plug-in connector, having at least the following method steps:
providing a sleeve-shaped contact element made of a metallic first material, which has a first lateral surface for making electrical and mechanical contact with a mating contact element of a mating electrical plug-in connector and a second lateral surface different from the first lateral surface;
providing a delimiting element, preferably made of a second material different from the first material, the delimiting element having a higher high-temperature strength than the contact element; and
fastening the delimiting element to the second lateral surface of the contact element at least in certain portions.

The use of the additional delimiting element, the starting material of which preferably has a high high-temperature strength, in particular a higher high-temperature strength than the starting material of the contact element, makes it possible to prevent or at least sufficiently suppress pressure-dependent and temperature-dependent deformation of the contact element, which is why the contact connection of the contact element with the mating contact element remains stable and operational over a long period of time.

Since the contact element is supported on the outside and/or on the inside (depending on the arrangement of the components), it is possible to establish a durable pressed connection or other connection between a contact element of a plug-in connector and a mating contact element of a corresponding mating plug-in connector. Consequently, even if the first material loses stability at high temperatures, the delimiting element makes it possible to prevent the contact element plastically deforming in such a way that the plug-in connection loses mechanical and/or electrical contact.

In one refinement of the invention, it may be provided that the contact element is produced by a die casting method, preferably from zinc, aluminum or from an alloy comprising zinc and/or aluminum.

Advantageously, it is therefore possible for the cost-effective and flexible shapability of the contact element to be utilized by a die casting process and combined with the high thermal stability provided by the separate delimiting element.

The delimiting element is preferably produced from a metallic material, in particular from iron, steel or brass.

Features that have been described in conjunction with one of the subjects of the invention, specifically given by the contact assembly according to the invention, the electrical plug-in connector according to the invention, the electrical plug-in connection according to the invention, the mating electrical plug-in connector according to the invention and the method according to the invention can also be advantageously implemented for the other subjects of the invention. Similarly, advantages that have been mentioned in conjunction with one of the subjects of the invention can also be understood as relating to the other subjects of the invention.

In addition, it is noted that expressions such as “comprising”, “having” or “with” do not exclude any other features or steps. Furthermore, expressions such as “a”, “an” or “the” which refer to a single number of steps or features do not exclude a plurality of features or steps, and vice versa.

In a puristic embodiment of the invention, however, it may also be provided that the features introduced in the invention by the terms “comprising”, “having” or “with” constitute an exhaustive list. Accordingly, within the context of the invention, one or more lists of features may be considered as self-contained, for example respectively for each claim. The invention can for example consist exclusively of the features specified in claim 1.

It should be mentioned that designations such as “first” or “second” etc. are used only for the purposes of being able to make a distinction between respective device or method features and are not necessarily intended to indicate that features require one another or are related to one another.

It should also be emphasized that the values and parameters described in the present document include deviations or fluctuations of ±10% or less, preferably ±5% or less, further preferably ±1% or less, and very particularly preferably ±0.1% or less in the respectively mentioned value or parameter, provided that these deviations are not ruled out when implementing the invention in practice. The specification of ranges by way of start and end values also comprises all those values and fractions that are included by the respectively mentioned range, in particular the start and end values and a respective mean value.

The invention also relates to a contact assembly, independent of claim 1, for a plug-in connector, having a contact element, wherein the contact element has a first lateral surface at least for making mechanical contact with a mating contact element of a mating plug-in connector and a second lateral surface different from the first lateral surface, and wherein the contact assembly moreover has a separate delimiting element, wherein the delimiting element is fastened to the second lateral surface of the contact element at least in certain portions, wherein the contact assembly preferably has a higher high-temperature strength than the contact element without the delimiting element. The further features of claim 1 and of the dependent claims and also the features described in the present description relate to advantageous embodiments and variants of this contact assembly.

### BRIEF DESCRIPTION OF THE FIGURES

Exemplary embodiments of the invention will be described in more detail below with reference to the drawings.

The figures each show preferred exemplary embodiments in which individual features of the present invention are illustrated in combination with one another. Features of one exemplary embodiment can also be implemented in isolation from the other features of the same exemplary embodiment and can accordingly be readily combined with features of other exemplary embodiments by a person skilled in the art to form further expedient combinations and sub-combinations.

Functionally identical elements are provided with the same reference signs in the figures.

In the figures, schematically:

FIG. 1 shows a perspective sectional illustration of an electrical plug-in connection composed of an electrical plug-in connector and a corresponding mating electrical plug-in connector, according to a first exemplary embodiment of the invention, wherein the plug-in connector has multiple contact assemblies according to the invention;

FIG. 2 shows a perspective sectional illustration of an electrical plug-in connection composed of an electrical plug-in connector and a corresponding mating electrical plug-in connector, according to a second exemplary embodiment of the invention, wherein the plug-in connector has multiple contact assemblies according to the invention;

FIG. 3 shows a sectional side view of an electrical plug-in connection composed of an electrical plug-in connector and a corresponding mating electrical plug-in connector, according to a third exemplary embodiment of the invention, wherein the plug-in connector has precisely one contact assembly according to the invention; and

FIG. 4 shows a method according to the invention for producing an electrical plug-in connector.

### DETAILED DESCRIPTION OF THE ENABLING EMBODIMENTS

FIG. 1 shows a perspective sectional illustration of an electrical plug-in connection 1, which has an electrical plug-in connector 2 and a mating electrical plug-in connector 3. This advantageously involves a high-voltage plug-in connection for the transmission of high electrical currents, in particular in vehicle engineering. In principle, however, the electrical plug-in connection 1 can also be suitable for high-frequency engineering or for any desired other electrotechnical applications.

The electrical plug-in connector 2 and the mating electrical plug-in connector 3 may in principle have any desired configuration, and in particular have any desired number of contact elements 4, 5, and mating contact elements 7, 8. In the exemplary embodiments, the electrical plug-in connector 2 purely by way of example has a sleeve-shaped external conductor contact element 4, in which run two internal conductor contact elements 5, which have a sleeve-shaped contact region. To fasten or guide the contact elements 4, 5 and to electrically insulate them from one another, in the exemplary embodiments the internal conductor contact elements 5 run through a dielectric 6 or through an insulator.

The mating plug-in connector 3 has a corresponding design to the plug-in connector 2 and has a (mating) external conductor contact element 7 and two (mating) internal conduct contact elements 8.

In the exemplary embodiments, to connect the plug-in connector 2 to the mating plug-in connector 3, a force fit is provided, preferably an interference fit between the respective contact elements 4, 5 and mating contact elements 7, 8. However, this should not be understood as limiting, since in principle the invention can be suitable for use with electrical plug-in connections 1 that are connected to one another in any desired way, for example also screwed to one another or latched to one another.

The contact element 4, 5 may be in particular a contact element 4, 5 produced by means of a die casting method, preferably from zinc, aluminum or an alloy comprising zinc and/or aluminum. A contact element 4, 5 of this type is generally not especially thermally stable, as a result of which the mechanical and electrical connection to the respective corresponding mating contact element 7, 8 can deteriorate at high temperatures. For example, sometimes temperatures of above 140° C. can arise in the event of high currents that occur in a high-voltage plug-in connector. In particular from 85° C., the materials produced in the course of a die casting method can easily lose their shape.

It is proposed in the present case to equip the electrical plug-in connector 2 with at least one contact assembly 9, which has a respective sleeve-shaped contact element 4, 5 made of a metallic first material, which contact element has a first lateral surface 10 for making electrical and mechanical contact with the corresponding mating contact element 7, 8 and a second lateral surface 11 different from the first lateral surface 10. The contact assembly 9 moreover has a delimiting element 12 made of a second material different from the first material, the second material having a higher high-temperature strength than the first material. In particular, the second material has a lower coefficient of thermal expansion than the first material. This delimiting element 12 is fastened to the second lateral surface 11 of the contact element 4, 5 at least in certain portions. In this way, the thermal stability of the contact element 4, 5 can be improved.

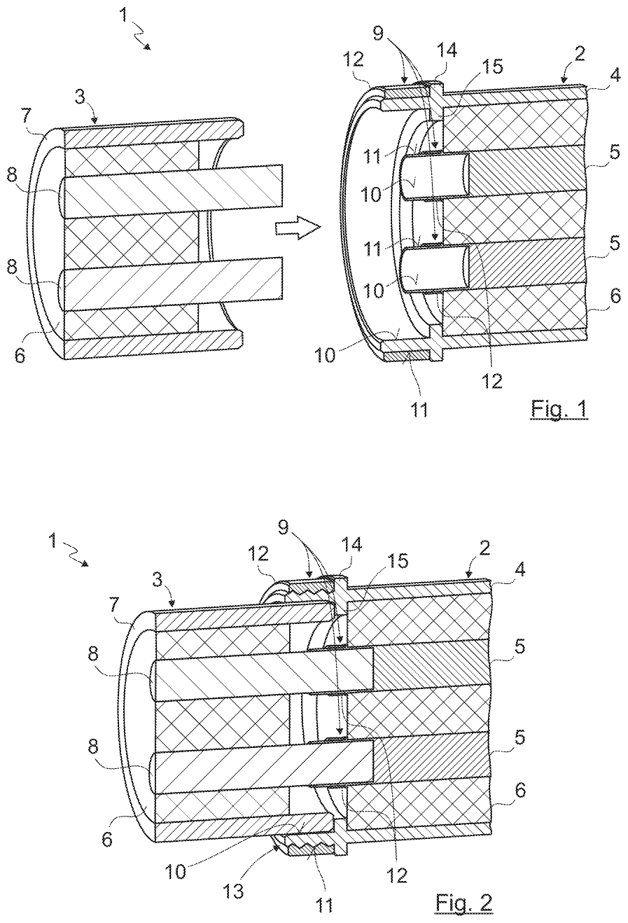

In the exemplary embodiment illustrated in FIGS. 1 and 2, three contact assemblies 9 for the electrical plug-in connector 2 are provided. In this case, a first contact assembly 9 has the external conductor contact element 4, a second contact assembly 9 has the first internal conductor contact element 5 and a third contact assembly 9 has the second internal conductor contact element 5. In principle, however, just one support only for the external conductor contact element 4 may be sufficient, for example.

In accordance with the exemplary embodiments of FIGS. 1 and 2, the contact elements 4, 5 of the contact assemblies 9 are designed to be plugged onto the corresponding mating contact element 7, 8 of the mating plug-in connector 3 (cf. in particular FIG. 2). The first lateral surface 10 of the respective contact element 4, 5 is therefore an inner surface of the contact element 4, 5 and the second lateral surface 11 for fastening the delimiting element 12 is an outer surface of the contact element 4, 5 that faces away from the inner surface. The respective contact element 4, 5 is therefore arranged between the respective delimiting element 12 and the corresponding mating contact element 7, 8, as a result of which the desired support is produced.

The proposed delimiting elements 12 may have, as illustrated, a sleeve-shaped or a ring-shaped form or at least have the form of part of a ring. The second material of the delimiting elements 12 is preferably a metallic material, in particular an iron material, steel material or brass material. The delimiting elements 12 extend circumferentially along the second lateral surface 11 of the respective contact element 4, 5 and rest on the second lateral surface 11 preferably over their entire surface area.

The delimiting element 12 may be fastened to the second lateral surface 11 of the contact element 4, 5 in particular directly by a force fit, for example by means of an interference fit between the delimiting element 12 and the contact element 4, 5, as illustrated in FIG. 1.

A possible alternative is shown in the second exemplary embodiment of FIG. 2, according to which the delimiting element 12 is fastened to the second lateral surface 11 via a threaded connection 13 formed between the delimiting element 12 and the second lateral surface 11 of the contact element 4, 5. However, the precise connecting technique between the delimiting element 12 and the contact element 4, 5 is fundamentally not important, provided that the delimiting element 12 makes it possible to correspondingly stabilize the contact element 4, 5 in the connected state.

For particularly good support of the contact element 4, 5, the delimiting element 12 is preferably fastened to an axial end portion of the contact element 4, 5 that is intended for connection to the mating contact element 7, 8. The delimiting element 12 may also extend for example from an axial end of the contact element 4, 5, as is illustrated with respect to the external conductor contact elements 4 in FIGS. 1 to 3. However, it is not absolutely necessary for the delimiting element 12 to extend from the axial end of the contact element 4, 5 (cf internal conductor contact elements 5 in FIGS. 1 and 2).

The use of multiple delimiting elements 12, which for example each run annularly around the circumference of the second lateral surface 11 and which are axially spaced apart from one another, in particular arranged axially offset in relation to one another, may also be provided.

In order to simplify the mounting and to provide a particularly robust plug-in connector 2, it may be provided that the contact element 4, 5 has a first axial stop 14, axially directly adjoining the second lateral surface 11, for the delimiting element 12. It is optionally also possible to provide a second stop 15 for the mating contact element 7, 8 of the mating plug-in connector 3.

The exemplary embodiments of FIGS. 1 and 2 each show the contact elements 4, 5 being supported on the outside. In principle, however, it is also possible to provide support for the contact element 4, 5 over the inner surface of the contact element 4, 5, as indicated in the third exemplary embodiment of FIG. 3. Consequently, the first lateral surface 10 of the contact element 4, 5, in FIG. 3 the external conductor contact element 4, may be an outer surface of the contact element 4, 5, and the second lateral surface 11 may be an inner surface facing away from the outer surface. This configuration can advantageously be suitable, for example, if the external conductor contact element 4 of the plug-in connector 2 is intended to be plugged into a mating contact element 7, in the form of a housing assembly, of the mating plug-in connector, as indicated in FIG. 3.

As is clear from the exemplary embodiment of FIG. 3, it is also not absolutely necessary to provide that all of the contact elements 4, 5 involved are made suitable by a delimiting element 12. In the exemplary embodiment of FIG. 3, the internal conductor contact elements 5 are in the form of straight pin contacts, for example, which can be plugged into corresponding mating contact elements 8 of the mating plug-in connector 3.

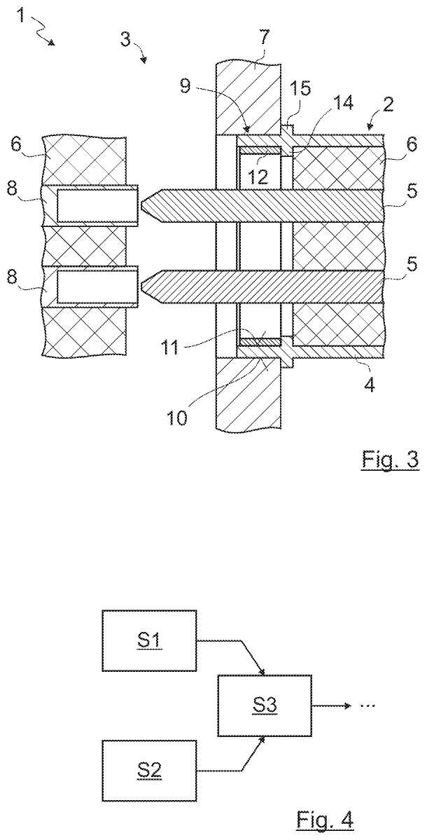

FIG. 4 shows an exemplary method sequence for producing a corresponding electrical plug-in connector 2.

According to a first method step S1, first of all the sleeve-shaped contact element 4, 5 can be provided. The contact element 4, 5 may preferably be produced by a die casting technique, in particular from zinc, aluminum or an alloy comprising zinc and/or aluminum.

In a second method step S2, which can be carried out in parallel with, but optionally also before or after, the first method step S1, the delimiting element 12 can be provided.

In a third method step S3 that follows the first two method steps S1, S2, the delimiting element 12 can be fastened to the second lateral surface 11 of the contact element 4, 5 at least in certain portions.

In principle, in the course of the proposed method, it is also possible to provide yet further method steps for producing the electrical plug-in connector 2. For example, the electrical plug-in connector 2 may be connected to an electrical cable and/or to a busbar. In principle, the proposed method can be combined with any desired known method steps for producing any desired electrical plug-in connectors.

What is claimed is:

1. A contact assembly for an electrical plug-in connector, comprising:
a contact element being sleeve-shaped and made of a metallic first material, wherein the contact element has a first lateral surface for making electrical and mechanical contact with a mating contact element of a mating electrical plug-in connector and a second lateral surface different from the first lateral surface; and
a delimiting element fastened to the second lateral surface of the contact element at least in certain portions and has a higher high-temperature strength than the contact element.

2. The contact assembly according to claim 1, wherein the second material has a lower coefficient of thermal expansion than the first material.

3. The contact assembly according to claim 1, wherein the first lateral surface:
a) is an inner surface of the contact element, and the second lateral surface is an outer surface, facing away from the inner surface, of the contact element; or
b) is an outer surface of the contact element, and the second lateral surface is an inner surface, facing away from the outer surface, of the contact element.

4. The contact assembly according to claim 1, wherein the delimiting element has a sleeve-shaped form or is at least partially in the form of part of a ring.

5. The contact assembly according to claim 1, wherein the second material of the delimiting element is a metallic material, preferably an iron material, steel material or brass material.

6. The contact assembly according to claim 1, wherein the delimiting element extends annularly circumferentially along the second lateral surface of the contact element, and wherein the delimiting element rests on the second lateral surface at least in certain portions.

7. The contact assembly according to claim 1, wherein the delimiting element is fastened to the second lateral surface of the contact element by a force fit, preferably by means of an interference fit between the delimiting element and the contact element.

8. The contact assembly according to claim 1, wherein the delimiting element is fastened to the second lateral surface via a threaded connection formed between the delimiting element and the second lateral surface of the contact element.

9. The contact assembly according to claim 1, wherein the delimiting element is fastened to an axial end portion of the contact element that is intended for connection to the mating contact element.

10. The contact assembly according to claim 1, wherein the contact element has a first axial stop, axially directly adjoining the second lateral surface, for the delimiting element.

11. The contact assembly according to claim 1, wherein the delimiting element is made from a second material different from the metallic first material of the contact element.

12. An electrical plug-in connector, in particular high-voltage plug-in connector, comprising: at least one contact assembly according to claim 1,
wherein the contact element of at least a first one of the contact assemblies mentioned is in the form of an external conductor contact element and/or wherein the contact element of at least a second one of the contact assemblies is in the form of an internal conductor contact element arranged within the external conductor contact element.

13. An electrical plug-in connection, having an electrical plug-in connector according to claim 12 and the mating electrical plug-in connector.

14. The electrical plug-in connection according to claim 13, wherein the contact element of the electrical plug-in connector is connected by a force fit to the mating contact element of the mating electrical plug-in connector in the connected state of the electrical plug-in connection, preferably by means of an interference fit between the contact element and the mating contact element.

15. A method for producing an electrical plug-in connector, comprising:
providing a sleeve-shaped contact element made of a metallic first material, which has a first lateral surface for making electrical and mechanical contact with a mating contact element of a mating electrical plug-in connector and a second lateral surface different from the first lateral surface;
providing a delimiting element having a higher high-temperature strength than the contact element; and
fastening the delimiting element to the second lateral surface of the contact element at least in certain portions.

16. The method according to claim 15, wherein the contact element is produced by a die casting method, preferably from zinc, aluminum or an alloy comprising zinc and/or aluminum.

17. The method according to claim 15, wherein the delimiting element is made from a second material different from the metallic first material of the sleeve-shaped contact element.
